(19) United States
(12) Patent Application Publication
(10) Pub. No.: US 2009/0276235 A1
(43) Pub. Date: Nov. 5, 2009

(54) METHODS AND SYSTEMS TO FACILITATE ETHNOGRAPHIC MEASUREMENTS

(76) Inventors: Karen Benezra, New York, NY (US); Mark Thomas Green, Winnetka, IL (US); Hala Makowska, Ossining, NY (US)

Correspondence Address: Hanley, Flight & Zimmerman, LLC, 150 S. Wacker Dr. Suite 2100, Chicago, IL, 60606, US

(21) Appl. No.: 12/434,294

(22) Filed: May 1, 2009

Related U.S. Application Data
(60) Provisional application No. 61/049,583, filed on May 1, 2008.

(51) Int. Cl. G06Q 99/00

(52) U.S. Cl. 705/1

(57) ABSTRACT

Example methods and apparatus to facilitate ethnographic measurements are disclosed. A disclosed example method includes transmitting a first survey question set to a wireless device associated with a respondent and receiving a response from the wireless device, the response indicative of a mood of the respondent, and transmitting a second survey question set to the respondent, the second survey question set based on the respondent mood.

### RELATED APPLICATION

This patent claims the benefit of U.S. provisional application Ser. No. 61/049,583, filed on May 1, 2008, which is hereby incorporated by reference herein in its entirety.

### FIELD OF THE DISCLOSURE

This disclosure relates generally to consumer behavior research and, more particularly, to methods and systems to facilitate ethnographic measurements.

### BACKGROUND

Understanding behavior of consumers is important to market research entities seeking to provide accurate purchase conduct data to clients, such as manufacturers of goods, advertisers, service providers, and/or merchants (e.g., retailers, wholesalers, etc.). Such conduct data is typically used by the manufacturers, service providers, and/or merchants to develop new products, marketing and/or advertising strategies. Additionally, empirical data related to shopper conduct may allow these entities to understand the degree of effectiveness of any implemented marketing and/or advertising strategy.

Some market research entities rely on aggregated sales data to determine one or more consumer trends, which may further illustrate a degree of success for promotional and/or advertising techniques related to a product and/or service. Additionally, panels may be employed by the market research entities to ask consumers questions to understand habits and/or discover unmet needs related to purchasing behavior and/or attitudes to one or more particular products and/or services.

Generally speaking, panels and/or focus groups of consumers reveal their attitudes during a single moment in time that coincides with the time at which the focus group is conducted. However, such attitudes may change based on the time of day, the day of week, and/or the season of the year. As such, a single point-in-time panel and/or focus group may not reveal one or more trends based on time.

### BRIEF DESCRIPTION OF THE DRAWINGS

FIG. 1 is a block diagram illustrating an example system that is configured to acquire consumer behavior data in a plurality of locations.

FIG. 2 depicts an example respondent survey tree that may be used for survey prompts to one or more respondents having a mobile device.

FIG. 3 depicts an example mobile diary manager that may be used with the example system of FIG. 1.

FIG. 4 illustrates an example central diary manager that may be used with the example system of FIG. 1.

FIG. 5 is an example behavior matrix generated by the example central diary manager of FIGS. 1 and 4.

FIG. 6 is an example perspectives matrix generated by the example central diary manager of FIGS. 1 and 4.

FIGS. 7-11 are flowcharts representative of example machine readable instructions that may be executed to facilitate ethnographic measurements.

FIG. 12 is a block diagram of an example processor system that may be used to execute the example machine readable instructions of FIGS. 7-10 to implement the example systems and/or methods described herein.

### DETAILED DESCRIPTION

Example methods and apparatus to facilitate ethnographic measurements are disclosed. A disclosed example method includes transmitting a first survey question set to a wireless device associated with a respondent and receiving a response from the wireless device, the response indicative of a mood of the respondent, and transmitting a second survey question set to the respondent, the second survey question set based on the respondent mood.

A disclosed example apparatus includes a central diary manager communicatively connected to a wireless device associated with a respondent and a central survey library to store a plurality of candidate survey questions for the respondent. The disclosed example apparatus also includes a respondent library to store respondent characteristics, and a communication interface to transmit a first survey question to the wireless device associated with the respondent, and to receive a first response based on the first survey question, the first response indicative of a mood of the respondent. The example apparatus also includes a central message generator to generate a second survey question from the plurality of candidate survey questions based on the mood of the respondent. As described in further detail below, the example central message generator may be implemented in any number of ways including, but not limited to a Short Message Service (SMS) generator.

Although the following discloses example systems including, among other components, software executed on hardware, it should be noted that such systems are merely illustrative and should not be considered as limiting. For example, it is contemplated that any or all of these hardware and software components could be embodied exclusively in hardware, exclusively in software, exclusively in firmware, or in any combination of hardware, firmware, and/or software. Accordingly, while the following describes example systems, the examples provided are not the only way to implement such systems.

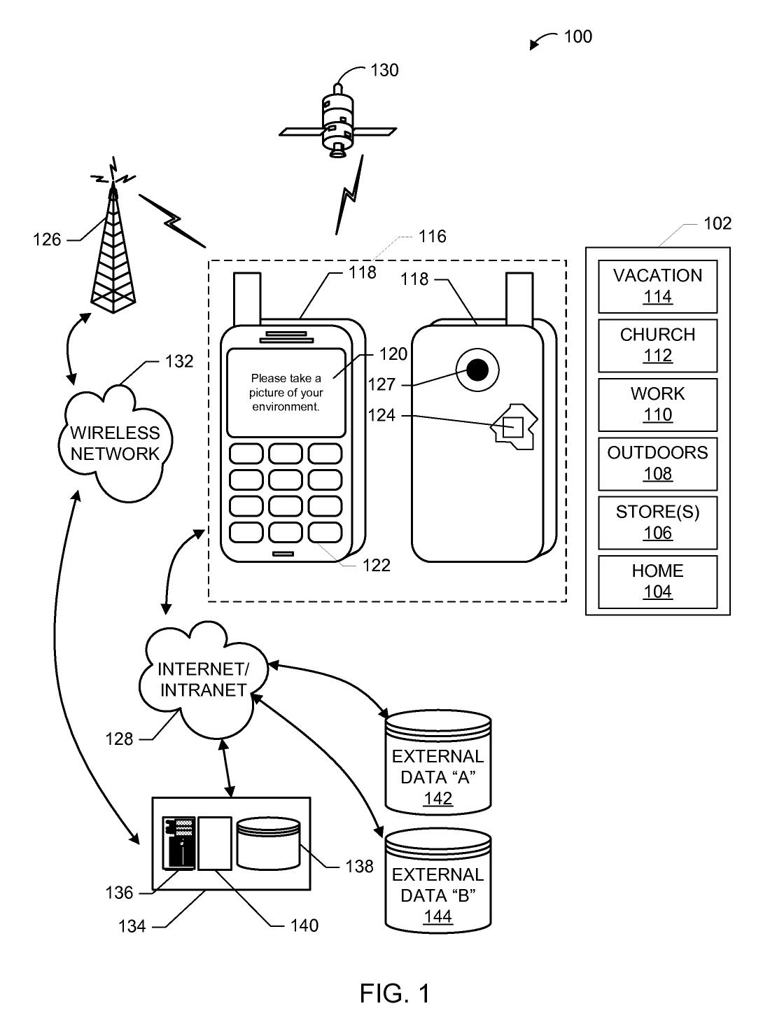

An example system 100 to facilitate ethnographic measurements is shown in FIG. 1. In general, the example methods and apparatus described herein enable metering of respondent behavior and/or sentiment using a mobile device. Ethnographic measurements reveal, in part, one or more aspects of a society based on information acquired from fieldwork that places the observer within the society and/or aspect of the society of interest. As such, unlike typical market research techniques that study actual sales data, ethnographic measurement techniques reveal additional information related to moods and/or attitudes, what people say, what people do, how people think, what people value, and/or further utilize information related to people, moods and/or attitudes, cultural norms, population behavior rhythms, and/or further utilize information related to moods and/or attitudes during the market research. Respondent moods and/or behavior determined via ethnographic measurement techniques described herein need not necessarily relate to one or more products and/or services from a merchant (e.g., retailer, wholesaler, service provider, etc.), but may also reveal general moods based on a current activity, a current location, a time of day, a day of week, and/or a season of the year. To that end, market researchers may better target new products, services, advertisement(s) and/or promotion(s) tailored to expected moods, thereby improving advertisement/promotional effectiveness. Without limitation, identifying respondent moods may further bolster an understanding of participating respondents, respondent characterization, and/or respondent trends.

Respondent behavior metered by the mobile device (e.g., wireless device, wireless telephone, cellphone, personal digital assistant (PDA), video camera, iPOD, etc.) includes, but is not limited to, respondent purchases, respondent mobility tracking, respondent mood, and/or answers to survey questions presented to the respondent. An example method of metering respondent behavior includes detecting when the respondent is proximate a retailer, forwarding a survey to the respondent, receiving survey response(s) from the respondent (e.g., via text message, electronic mail (e-mail), audio voice responses, video, audio/visual (A/V), etc.), and receiving a photo captured by the mobile device during the survey response(s). Additionally, the methods and systems described herein associate one or more tags to each received photo and/or survey response, including responses related to respondent mood(s). The tags permit generation of one or more behavior table(s) and/or perspective table(s) to reveal, for example, which combinations of times, activities, places, and/or conditions create one or more moods (e.g., happiness, depression, energetic, tired, engagement, boredom, concentration, multitasking, etc.). Market researchers may further determine particular opportunities for advertising effectiveness based on such moods. For example, market researchers may determine that consumers are more apt to respond to an advertisement and/or promotion when in a good mood, and may further identify when such good moods are likely to occur. Additionally or alternatively, collection and identification of respondent mood information may facilitate survey question selection and/or generation that is more effective when presented to the respondent. In some circumstances, a respondent that is, for example, particularly tired or sad may not be receptive to certain types of survey questions. In other circumstances, survey questions that are specifically tailored to the respondent's mood may allow a market researcher to better understand environmental conditions and/or how such conditions may elicit respondent behaviors and/or behavior pattern(s).

FIG. 1 is an example system 100 having one or more example geographic areas 102 in which the example methods, systems, and apparatus described herein may operate. The example geographic areas 102 include, but are not limited to, the respondent's home 104, stores 106 visited by the respondent, outdoors location(s) 108 such as parks, the respondent's place of work 110, church 112, recreation areas, and/or one or more vacation destination(s) 114. An example mobile device 116 is carried by the respondent at any of the example geographic areas 102 to facilitate acquisition of ethnographic measurements.

In the illustrated example of FIG. 1, the mobile device 116 is a wireless telephone 118 equipped with a user interface display 120, a user input 122, a camera 127, and a mobile diary manager 124. The wireless telephone 118 and/or any other mobile device 116 of the illustrated example employ any type of communication technique(s) and/or communication system(s) including, but not limited to, RF transceiver tower(s) 126 (e.g., GSM, CDMA, TDMA, 3G, etc.), network(s) (e.g., Wi-Fi, Internet, intranet) 128, and/or satellite(s) 130. As discussed in further detail below, the example mobile device 116 of FIG. 1 may be enabled with global positioning system (GPS) transceivers, thereby allowing users to utilize satellites 130 to determine geographic location information. The example RF transceiver towers 126 are communicatively connected to a wireless network 132 of a service provider, such as a wireless (e.g., cellular) telephone service provider and/or an Internet service provider. Either the wireless network 132 and/or the network 128 may communicatively connect the mobile device 116 with an example central facility 134.

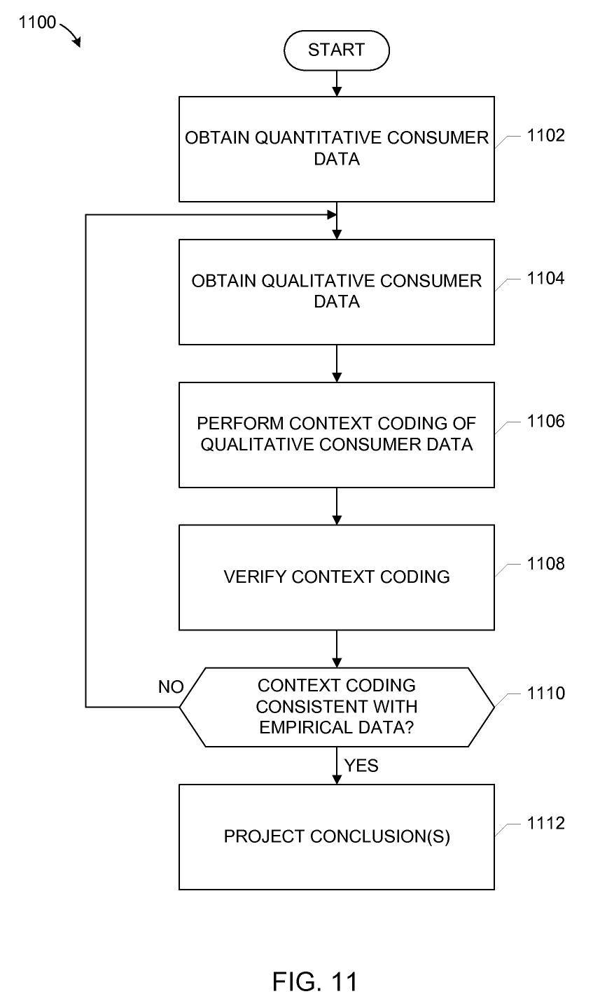

In the illustrated example of FIG. 1, the central facility 134 includes a server 136 (e.g., a central processor system, a web server, a database query engine, etc.) and at least one database 138. The database 138 may be implemented using any suitable memory, or data storage apparatus and/or techniques. The server 136 may be implemented using, for example, a processor system similar or identical to the example processor system 1110 depicted in FIG. 11 that is configured to process, store, and/or provide information collected from the example mobile device(s) 116. Additionally, the central facility 134 includes a central diary manager 140 to facilitate ethnographic data capture and measurements in the example system 100. The example central facility 134 of FIG. 1 is communicatively connected to a first external data source 142 and a second external data source 144. Although the illustrated example of FIG. 1 includes two example external data sources, 142 and 144, the methods and apparatus described herein are not limited thereto. As discussed in further detail below, the external data sources 142, 144 may include database(s) and/or service(s) such as those available from Claritas® and/or TDLinx® to determine one or more aspects of a merchant, such as trade area characteristics, customer information, demographics information, and/or physical site characteristics.

In operation, a respondent with a mobile device 116, such as the example wireless telephone 118 (e.g., a cellular telephone), receives a survey prompt once every, for example, waking hour of a day, responds to the survey with text and image information, and transfers such survey responses back to the central facility 134. Additionally or alternatively, the respondent may utilize the mobile device 116 manually (e.g., voluntarily) to commence one or more survey activities, and/or to acquire/record quantitative and/or qualitative environmental data related to the respondent's surroundings. As discussed in further detail below, the survey prompt(s) may be tailored based on the respondent's mood and/or where the respondent is located (e.g., at home, near a coffee store, near a clothing store, etc.), and/or tailored to branch-into alternate/additional questions based on responses to the survey question(s). Survey question branching may be tailored based on, for example, respondent profile information (e.g., age, sex, income, etc.), respondent mood (e.g., happy, sad, etc.), and/or any combination of respondent mood and/or other respondent characteristics and/or environmental parameters.

Without limitation, the frequency of survey prompts may be greater or lesser, and/or may occur based on a manual and/or automatic prompt from the example central facility 134. Also without limitation, the example mobile device 116 may include a smart telephone, a pager, a personal digital assistant (“PDA”), a handheld wireless computer, or any other wireless communication device having communication capabilities to transfer information to/from the central facility 134. The survey prompt may include one or more survey questions for the respondent to read on the user interface display 120, and survey answers may be provided by the respondent via the user input 122. The example user input 122 may be a numeric keypad having alphabetic character selection capabilities and/or a miniaturized keypad having alphanumeric keys, such as, for example, a “QWERTY” keyboard.

In the illustrated example of FIG. 1, survey questions are presented to the respondent via the example user interface display 120 as messages (e.g., text messages via the SMS communication protocol), e-mail messages, blog update(s) (e.g., Twitter®, Facebook®, etc.) audio prompts, and/or A/V prompts. Similarly, responses to the survey question(s) may be typed by the respondent as SMS messages, e-mail messages, voice recorded audio messages, and/or A/V multimedia messages. Survey questions may also include a request to have the respondent take a picture and/or video of a scene and/or item(s) that currently have their attention/focus (e.g., a picture of the respondent's surroundings). For example, in the event that the respondent is brushing his teeth when a survey prompt is received by the mobile device 116, the respondent may take a photo of a toothbrush, a toothpaste product, a sink, and/or a bathroom. In another example, in the event that the respondent is shopping at a retail store when a survey prompt is received by the mobile device 116, the respondent may take a photo of the item(s) of interest, a barcode of item(s) of interest, a shelf of products that the respondent is evaluating, and/or a photo of the inside of the retail store (e.g., the men's department, the sporting goods department, etc.).

Survey questions provided from the central office 134 (e.g., the central diary manager 140) to the mobile device 116 may be based on, for example, the respondent's location as determined by GPS data provided by the mobile device 116, the respondent's expected mood based on previous respondent profile information, and/or other respondent characteristics. For example, if the mobile device 116 transmits one or more latitude/longitude coordinates along with respondent survey responses, the central diary manager 140 may invoke one or more external data sources, such as Claritas®, to determine which retail stores are nearest to the respondent and/or the type(s) of retail stores nearest to the respondent. Further, in view of the information related to the retail landscape within which the respondent is currently located, the example central diary manager may assemble branch/follow-up survey questions for the respondent to answer. To illustrate, if the Claritas® services indicate that the respondent is inside a Starbucks® coffee store, the example central diary manager 140 generates follow-up questions to provide at least one promotional offer, learn whether the respondent bought any coffee, what type of coffee was purchased, and/or whether any non-food/beverage items were also purchased with the coffee (e.g., coffee filters, music CD's, etc.). Without limitation, follow-up questions (e.g., a second survey question set) may be forwarded to the respondent based on a currently disclosed mood and/or activity of the respondent.

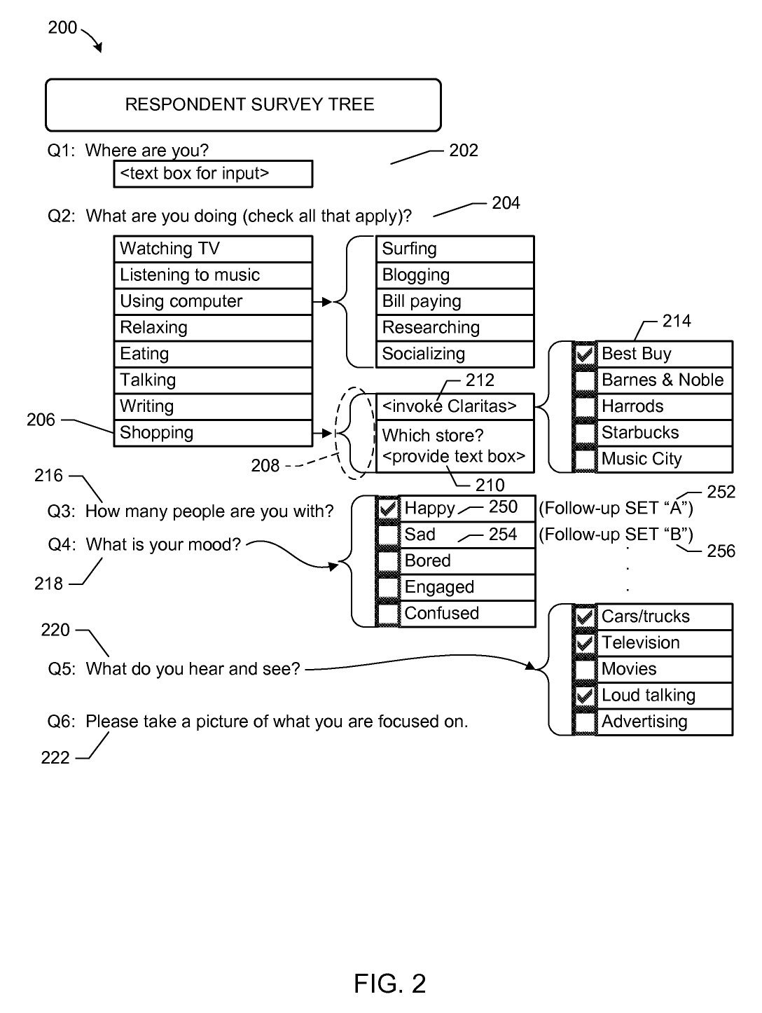

FIG. 2 illustrates an example survey tree 200 listing survey questions capable of being transmitted to the mobile device 1 16. The example survey tree 200 may be stored in the example database 138 of the central office 134 or any other memory location. A first example question 202 asks the respondent “Where are you?” A second example question 204 asks the respondent “What are you doing?” As described above, responses to a survey question may be returned by the respondent via any type of message (e.g., text message, blog entry, audio message, video message, etc.) and/or the respondent may be presented with one or more list items, each of which may be selected or de-selected with a checkbox via the example user input 122. In the event that the respondent identifies “Shopping” in response to a question related to a current activity, the example survey tree 200 includes a branch 208 with each leg including further survey question(s) (e.g., follow-up questions, questions tailored based on prior response(s), etc.). If the mobile device 116 does not include a GPS transceiver, then the branch 208 may follow a non-GPS path 210 and ask the respondent to identify which store was (or is) visited. On the other hand, if the mobile device 116 includes a GPS transceiver, then the branch 208 may follow a GPS path 212 that provides the respondent's current latitude/longitude to an external data source (142, 144), such as a Claritas® database. The external data source (142, 144) may reveal a list of retailers near the respondent and present such list on the example interface display 120 for the respondent to acknowledge via, for example, checkboxes 214 selectable with the example user input 122. The acknowledgement may recognize proximity and/or may indicate the store that was visited.

In the illustrated example of FIG. 2, the survey tree 200 also presents the respondent with one or more questions regarding other people in the presence of the respondent 216. A list of moods that the respondent is experiencing 218 and one or more items and/or situations that the respondent is hearing and/or seeing 220 are also included in the example survey tree 200 of FIG. 2. One or more actions 222 may also be requested via the example survey tree 200, such as a request to have the respondent take a picture of the current environment and/or an item on which the respondent is focused. Without limitation, the actions requested by the example survey tree 200 may include recording audio of the environment of the respondent.

In the illustrated example of FIG. 2, one or more follow-up survey questions and/or sets of survey questions are generated in response to example questions Q1 through Q6. For example, in response to a respondent mood response 218 as experiencing a happy mood 250, the example mobile diary manager 124 and/or the example central diary manager 140 may cause follow-up question set A 252 to be displayed and/or otherwise presented to the respondent. Similarly, in the event that the respondent identifies a current mood of sad 254, then a corresponding question set B 256 may be tailored to reflect one or more questions deemed appropriate when the respondent is sad.

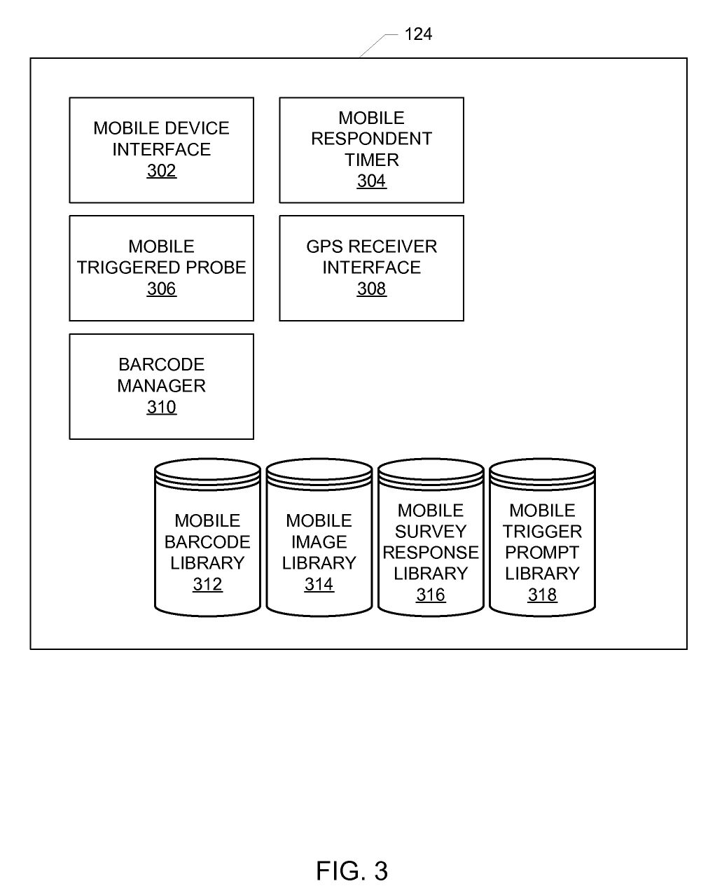

FIG. 3 illustrates an example implementation of the mobile diary manager 124 of FIG. 1 described above. In the illustrated example of FIG. 3, the mobile diary manager 124 includes a mobile device interface 302, a mobile respondent timer 304, a triggered probe 306, and a GPS receiver interface 308. Additionally, the example mobile diary manager 124 of FIG. 3 includes a barcode manager 310, a mobile barcode library 312, a mobile image library 314, a mobile survey response library 316, and a mobile trigger prompt library 318.

The example mobile device interface 302 provides the mobile diary manager 124 access to one or more features and/or functions of the mobile device 116. For example, the mobile device interface 302 may be implemented as a firmware or software interface to a wireless telephone, such as an example software interface developed with a software development kit (SDK) provided by a manufacturer of the mobile device 116. Functions facilitated by the example mobile device interface 302 include, but are not limited to, sending/receiving survey questions and/or answers (e.g., via SMS messaging, e-mail, audio, A/V, blog feeders, Twitter®, Facebook®, etc.), and accessing mobile device features (e.g., GPS transceivers, camera, wireless transceiver(s) (GSM, CDMA, TDMA, 3G, etc.), Wi-Fi radio, etc.).

The example mobile respondent timer 304 allows, in part, the example mobile device manager 124 to initiate survey questioning to the respondent on a periodic and/or scheduled basis. Surveys may also be self-initiated based on one or more particular activities (e.g., spending money, eating, household chores, etc.) For example, in the event that the mobile device 116 is out of range for wireless communication (e.g., building interference, non-cellular coverage, non-radio mode, etc.), then the example mobile respondent timer 304 may invoke survey questioning from one or more survey questions stored in a memory, such as the example mobile trigger prompt library 318. Additionally, one or more answers to the survey questions may be stored in the example mobile survey response library 316 and transmitted to the example central diary manager 140 once wireless communication to the mobile device 116 is restored.

The example mobile triggered probe 306 evaluates one or more events (e.g., SMS messages, Twitter® feed updates, etc.) that are received by the example mobile device 116 to determine whether such messages are associated with survey questions or not. In the event that a received event, such as one or more SMS message(s) transmitted by the central diary manager 140, is/are associated with survey question(s), the example mobile triggered probe 306 stores the received message(s) in the mobile trigger prompt library 318 for future presentation to the respondent. For example, the survey question(s) stored as SMS message(s) in the mobile trigger prompt library 318 may be retrieved by the mobile triggered probe 306 upon receipt of notification from the mobile respondent timer 304 that a survey should occur. Without limitation, the mobile triggered probe 306 may also initiate presentation of the event(s) (e.g., one or more SMS message(s)) to the respondent upon receipt of such event(s) from the central diary manager 140.

In the illustrated example of FIG. 3, the mobile diary manager 124 invokes the GPS receiver interface 308 to further invoke GPS features and/or hardware of the example wireless device 116. Data retrieved in response to the GPS receiver interface 308 may include one or more latitude and/or longitude coordinates. Such coordinates may be transmitted from the wireless device 116 to the central diary manager 140 to determine one or more retailers that the respondent is near, as described above and as described in further detail below. Without limitation, the example GPS receiver interface 308 may employ one or more wireless triangulation techniques to identify a respondent location.

The example barcode manager 310 invokes the camera 127 and prompts the respondent to take a picture of a barcode for a retail item. The barcode manager 310 evaluates the received barcode picture image and extracts the numeric, alphabetic, symbolic, and/or alpha-numeric content (e.g., characters) associated with the product barcode (e.g., a Universal Product Code (UPC), a serial number, etc.), and/or other materials embedded in a product or associated packaging. The extracted characters are stored in the mobile barcode library 312 for later transmission to the example central diary manager 140. Additionally or alternatively, the example mobile barcode library 312 includes a list of products and associated UPC values that, upon comparison to the extracted characters, allow the mobile diary manager 124 to confirm with the respondent which product was just photographed. For example, in the event that the respondent takes a photo of a barcode for a container of Purell® hand sanitizer, the barcode manager 310 extracts a UPC value of “3 52800 65880 7.” If the mobile barcode library 312 also contains the extracted barcode value, then the barcode manager 310 may cause the mobile diary manager 124 to issue a text prompt on the user interface 120 that states, “Did you just photograph a container of Purell® hand sanitizer?” In another example, the mobile diary manager 124 may prompt the user interface 120 with a statement, “Did you pay in cash, use a coupon, or see a product review for this item?” On the other hand, if the example mobile barcode library 312 does not include a matching barcode value, then the barcode manager 310 may cause the mobile diary manager 124 to transmit the extracted code to the central diary manager 140 to perform a lookup operation.

Additionally, any photos, audio, and/or A/V taken as a result of survey prompt(s) are stored in the mobile image library 314, which are later transmitted or otherwise transferred to the central diary manager 140. Each of the mobile barcode library 312, the mobile image library 314, the mobile survey response library 316, and/or the mobile trigger prompt library 318 may be implemented in any type of memory of the example mobile device 116. Without limitation, such memory may include one or more flash memory devices, secure digital (SD) card(s), mini SD card(s), micro SD card(s), and/or compact flash (CF) card(s).

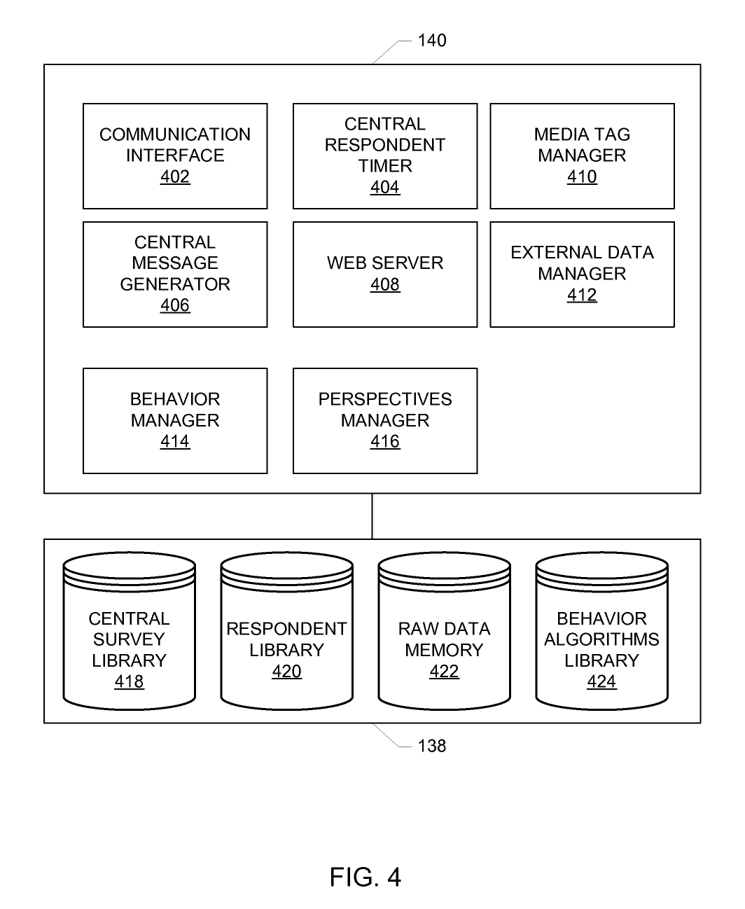

FIG. 4 illustrates an example implementation of the central diary manager 140 of FIG. 1 described above. In the illustrated example of FIG. 4, the central diary manager 140 includes a communication interface 402, a central respondent timer 404, a central message generator 406 (e.g., an SMS generator), a web server 408, and a media tag manager 410. Additionally, the example central diary manager 140 includes an external data manager 412, a behavior manager 414, and a perspectives manager 416. As shown in FIG. 4, the example central diary manager 140 is communicatively connected to the database 138, which further includes a central survey library 418 to store candidate survey questions, a respondent library 420, a raw data memory 422, and a behavior algorithms library 424.

The example communication interface 402 of FIG. 4 facilitates, in part, communication between the central diary manager 140 and the database 138, the external data source(s) (142, 144), the network(s) 128, and/or the wireless network 132. In some example(s), the wireless network 132 may include a wireless telecommunication company and/or a land-line telecommunication company. In other examples, the network(s) 128 may include one or more connections to an intranet and/or the Internet.

The example central respondent timer 404 initiates a respondent survey on a periodic basis and/or a scheduled basis by invoking one or more components of the central diary manager 140 to forward survey questions to one or more respondents. For example, the central respondent timer 404 may be configured to respond once each hour during weekdays between the hours of 7:00 A.M. and 6:00 P.M., but may be configured to respond once each hour during weekends between the hours of 9:00 A.M. and 10:00 P.M. Without limitation, the frequency with which one or more surveys is administered by the example central diary manager 140 may be increased or decreased to any value, and/or self-initiated surveys may be conducted in between one or more scheduled times.

The example central message generator 406 prepares one or more survey questions for a respondent and, once a survey set of questions is generated, invokes the communication interface to transmit such set of survey questions to the mobile diary manager 124 for a selected respondent. In operation, the example central message generator 406 may generate the example set of six questions (e.g., Q1-Q6 as one or more SMS messages) as shown in FIG. 2. Additionally or alternatively, the example central message generator 406 may generate one or more sets of survey questions based on details known about the respondent (e.g., sex, age, income, hobbies, mood trends, etc.), available respondent activities based on regional geographic information (e.g., respondent proximity to lakes (e.g., for sailing), mountains (e.g., for hiking), forests (e.g., for hunting), nightclubs, concert halls, sports stadiums, etc.), a known location of the respondent (e.g., based on received GPS information), a time of day, a day of the week, seasonal information, the respondent's current mood, a number of people with the respondent, and/or any combination thereof. For example, a survey question generated by the example central message generator 406 may be based on a known recent snowstorm during the winter by virtue of weather data acquired by the example external data manager 412 access to a weather website. Further to that example, the generated survey question may include, “How is your mood after shoveling your driveway?” Any number of survey questions and/or sets of survey questions may be stored in the example central survey library 418, which may further be stored on the database 138 and contain one or more candidate survey questions to be presented to respondents.

In the event that the respondent is at home, or any other location in which the respondent has access to a computer connected to the internet, the example web server 408 of FIG. 4 facilitates one or more personalized web-screens for the respondent. While the example mobile device 116 may ring and/or vibrate to alert the respondent that it is time to complete another survey, the respondent may prefer to complete the survey with a computer having a full-size keyboard, if readily available. Additionally, the example web server 408 of FIG. 4 facilitates, in part, respondent personal journals, pre-surveys, and/or post-surveys.

In the illustrated example of FIG. 4, the media tag manager 410 associates at least one tag with each survey response submitted by the respondent, each photo submitted by the respondent, and/or each audio clip recorded by the respondent. Tags may include, but are not limited to places or activities. Example place tags may include “at home,” “at work,” “friend's house,” and/or “vacation destination.” Additionally, example activity tags may include “commuting,” “entertaining,” “playing,” “exercising,” “working,” “studying,” “shopping,” and/or “watching television.” The example media tag manager 410 may associate each survey response and/or other media (e.g., a photo) with more than one tag, including one or more tags also related to the mood of the respondent. Mood tags may include, but are not limited to, “happy,” “sad,” “bored,” “engaged,” “confused,” and/or “depressed.”

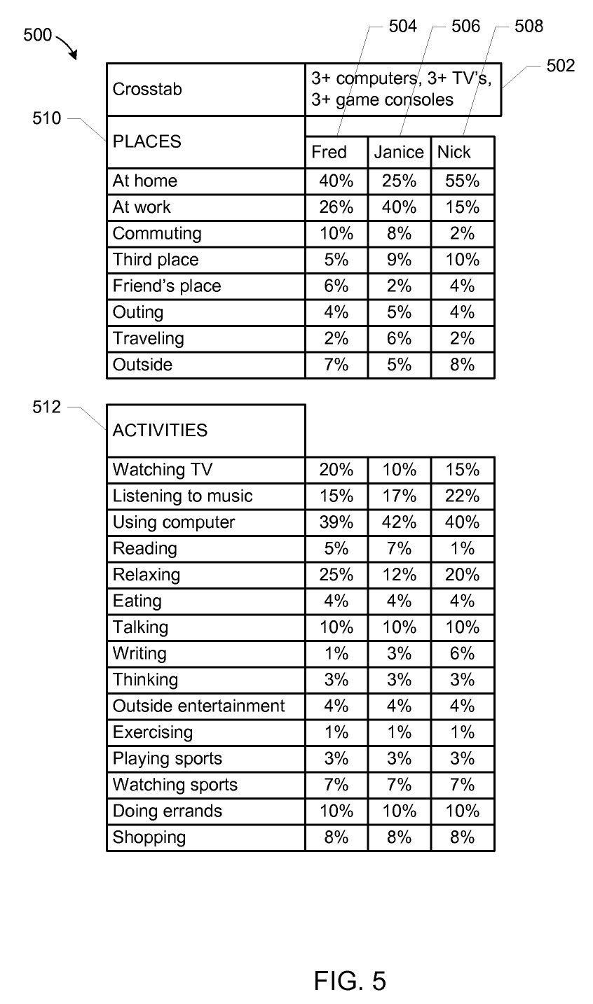

Data collected from respondents on a periodic and/or scheduled basis is stored, along with one or more tags, in the raw data memory 422. To determine one or more behaviors associated with each respondent, the example behavior manager 414 generates one or more behavior matrices, such as the example behavior matrix 500 shown in FIG. 5. The matrices may include a crosstab of interest, in which each crosstab generally defines a sub-group of respondents and one or more common traits associated with such sub-group of respondents. In the illustrated example of FIG. 5, the matrix 500 includes a crosstab 502 defined as respondents having three or more computers, three or more television sets, and three or more game devices in their home. Three members of the example matrix 500 that meet all qualifications of the selected example crosstab 502 are Fred 504, Janice 506, and Nick 508. Each of the members includes a column of percentage values to represent a relative amount of time spent in place segments 510 and activity segments 512.

In addition to mapping out relative percentage values for each respondent within a crosstab of interest, the example behavior manager 414 of FIG. 4 determines one or more conclusions from the example matrix 500 data. The illustrated example behavior manager 414 of FIG. 4 retrieves one or more behavior algorithms from the behavior algorithms library 424 and applies respondent data to the retrieved algorithms to generate one or more conclusions. For example, the behavior manager 414 concludes that, although Nick 508 spends a relatively large portion of time at home (i.e., 55%), because a relatively large portion of time is also spent using a computer (i.e., 40%), Nick is likely a person who works out of his home.

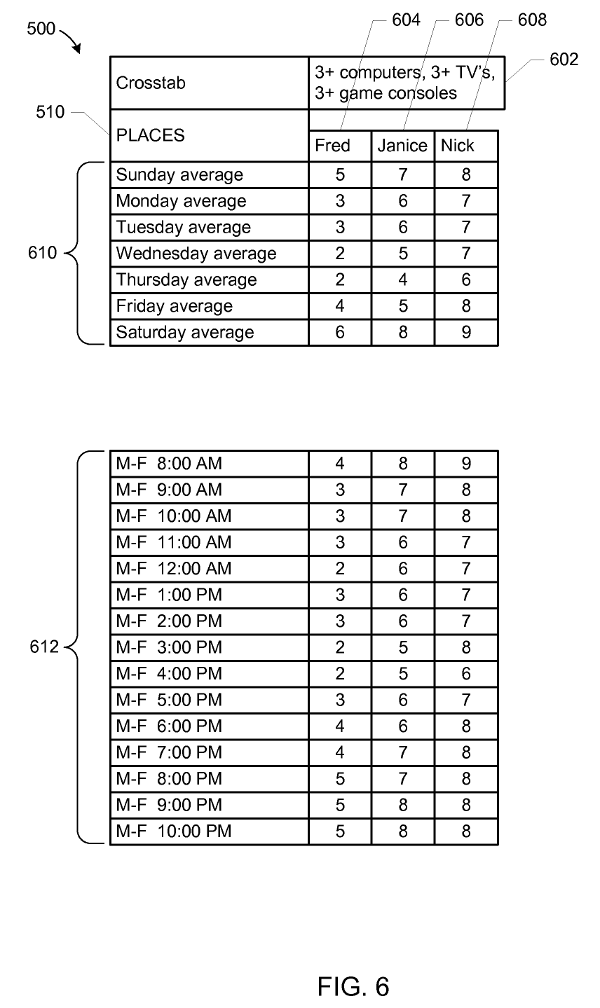

To determine and/or uncover respondent wants, needs, behaviors, and/or opportunities based on mood, the example perspectives manager 416 generates one or more matrices for a corresponding crosstab. In the illustrated example of FIG. 6, a perspective matrix 600 includes a crosstab 602 having members Fred 604, Janice 606, and Nick 608. Each member includes a column having mood levels on a scale from happy (mood=10) to depressed (mood=1). Additionally, each member's moods are listed based on daily averages 610 and hourly averages 612 during a regular workweek.

The example perspective matrix 600 of FIG. 6 allows market researchers to better identify particularly opportunistic times during a week in which advertising and/or promotions are more effective. Additionally, market researchers are better able to identify, for example, when a respondent is engaged with a certain type of media that is likely to be more receptive (e.g., effective) to high energy advertising techniques (e.g., at the beginning of a weekend), versus advertising techniques that target a more pensive audience (e.g., at the end of a weekend).

While an example manner of implementing the mobile diary manager 124 of FIG. 1 has been illustrated in FIG. 3, and an example manner of implementing the central diary manager 140 of FIG. 1 has been illustrated in FIG. 4, one or more of the elements, processes and/or devices illustrated in FIGS. 3 and 4 may be combined, divided, re-arranged, omitted, eliminated and/or implemented in any other way. Further, the example mobile device interface 302, the example mobile respondent timer 304, the example mobile triggered probe 306, the example GPS receiver interface 308, the example barcode manager 310, the example communication interface 402, the example central respondent timer 404, the example central message generator 406, the example web server 408, the example media tag manager 410, the example external data manager 412, the example behavior manager 414, and/or the example perspectives manager 416 of FIGS. 3 and 4 may be implemented by hardware, software, firmware, and/or any combination of hardware, software, and/or firmware. Thus, for example, any of the example mobile device interface 302, the example mobile respondent timer 304, the example mobile triggered probe 306, the example GPS receiver interface 308, the example barcode manager 310, the example communication interface 402, the example central respondent timer 404, the example central message generator 406, the example web server 408, the example media tag manager 410, the example external data manager 412, the example behavior manager 414, and/or the example perspectives manager 416 could be implemented by one or more circuit(s), programmable processor(s), application specific integrated circuit(s), (ASIC(s)), programmable logic device(s) (PLD(s)) and/or field programmable logic device(s) (FPLD(s)), etc. When any of the appended claims are read to cover a purely software implementation, at least one of the example mobile device interface 302, the example mobile respondent timer 304, the example mobile triggered probe 306, the example GPS receiver interface 308, the example barcode manager 310, the example communication interface 402, the example central respondent timer 404, the example central message generator 406, the example web server 408, the example media tag manager 410, the example external data manager 412, the example behavior manager 414, and/or the example perspectives manager 416 are hereby expressly defined to include a tangible medium such as a memory, DVD, CD, etc. Further still, the example mobile diary manager 124 and/or the example central diary manager 140 of FIGS. 1, 3, and 4 may include one or more elements, processes, and/or devices in addition to, or instead of, those illustrated in FIGS. 1, 3, and 4, and/or may include more than one of any or all of the illustrated elements, processes and devices.

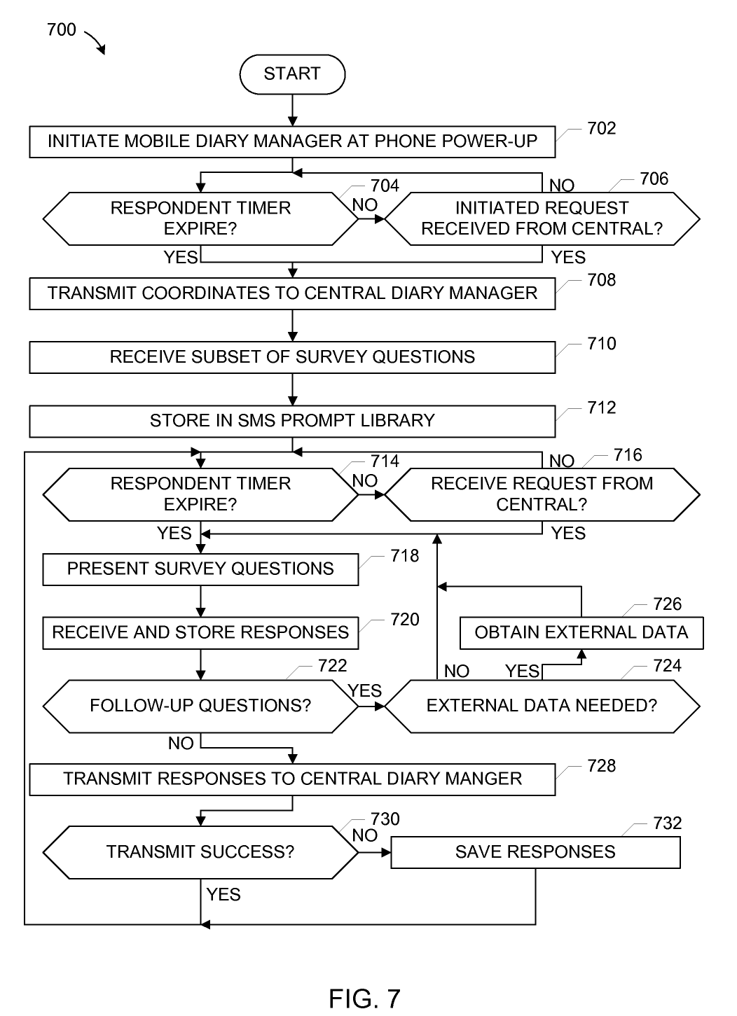

Flowcharts representative of example machine readable instructions for implementing the system 100 of FIGS. 1, 3, and 4 are shown in FIGS. 7-10. In this example, the machine readable instructions comprise one or more programs for execution by one or more processors such as the processor 1112 shown in the example processor system 1110 discussed below in connection with FIG. 11. The program(s) may be embodied in software stored on a tangible medium such as a CD-ROM, a floppy disk, a hard drive, a digital versatile disk (DVD), a read-only memory (ROM), a random-access memory (RAM), a programmable ROM (PROM), an electronically-programmable ROM (EPROM), an electronically-erasable PROM (EEPROM), an optical storage disk, an optical storage device, magnetic storage disk, or a memory associated with the processor 1112, and/or any other medium that can be used to carry or store program code and/or instructions in the form of machine-readable instructions or data structures, and that can be accessed by a processor, a general-purpose or special-purpose computer, or other machine with a processor, such as the example processor 1112 discussed below in connection with FIG. 11 and/or embodied in firmware or dedicated hardware. Combinations of the above are also included within the scope of computer-readable media. Machine-readable instructions comprise, for example, instructions and/or data that cause a processor, a general-purpose computer, a special-purpose computer, or a special-purpose processing machine to implement one or more particular processes. For example, any or all of the mobile diary manager 124, the central diary manager 140, the mobile device interface 302, the mobile respondent timer 304, the mobile triggered probe 306, the GPS receiver interface 308, the barcode manager 310, the communication interface 402, the central respondent timer 404, the central message generator 406, the web server 408, the media tag manager 410, the external data manager 412, the behavior manager 414, and/or the perspectives manager 416 could be implemented (in whole or in part) by any combination of software, hardware, and/or firmware.

Thus, for example, any of the example mobile diary manager 124, the central diary manager 140, the mobile device interface 302, the mobile respondent timer 304, the mobile SMS manager 306, the GPS receiver interface 308, the barcode manager 310, the communication interface 402, the central respondent timer 404, the central SMS generator 406, the web server 408, the media tag manager 410, the external data manager 412, the behavior manager 414, and/or the perspectives manager 416 could be implemented by one or more circuit(s), programmable processor(s), ASIC(s), PLD(s) and/or FPLD(s), etc. Further, although the example program is described with reference to the flowchart illustrated in FIGS. 7-10, many other methods of implementing the example system 100 may alternatively be used. For example, the order of execution of the blocks may be changed, and/or some of the blocks described may be changed, divided, eliminated, and/or combined.

FIG. 7 is a flowchart representative of machine readable instructions 700 that may be executed to operate one or more features of the mobile diary manager 124 of FIGS. 1 and 3. The program of FIG. 7 (700) begins at block 702 where the example mobile diary manager 124 is initiated upon power-up of the example mobile device 116, such as the example wireless telephone 118 shown in FIG. 1. If the example mobile respondent timer 304 time-period has not expired (e.g., a time-period of sixty-minutes) (block 704), then the example mobile device interface 302 determines whether the example central diary manager 140 has initiated a request to provide the mobile device 116 with one or more survey questions, such as a set of respondent survey questions (block 706). As shown in FIG. 7, the program 700 includes at least two ways in which one or more respondent surveys may be provided to the example wireless device 116. That is, respondent survey question(s) may be provided to the mobile device 116 in response to expiration of a time-period of the example mobile respondent timer 304 and/or one or more signal(s) from the central diary manager 140. However, populating the mobile device 116 with respondent survey questions is not limited to the expiration of one or more periodic time thresholds and may, additionally or alternatively, begin population of one or more respondent survey question-set(s) based on a scheduled date and/or time as determined by the mobile respondent timer 304, the central respondent timer 404, and/or manual initiation by a market researcher. For example, the market researcher may draft and/or otherwise make available one or more new and/or alternate survey question(s) that are to be used during respondent survey(s), thus such market researcher may manually initiate an upload of such new/alternate survey questions to the mobile device(s) 116.

In response to initiation of a respondent survey, the example program 700 causes the GPS receiver interface 308 to obtain one or more location coordinates of the mobile device 116 and transmit such coordinates to the central diary manager 140 (block 708). As discussed in further detail below, the central diary manager 140 may generate a set of survey questions based on any number of parameters, such as the current location of the mobile device 116, the time of day, the day of the week, the respondent's expected mood (e.g., from previous respondent mood tracking information), the respondent's currently disclosed mood, respondent characteristics, weather, and/or seasonal information (e.g., winter, spring, summer, fall, holidays, etc.). The mobile device interface 302 of the mobile diary manager 124 receives one or more survey questions from the central diary manager 140 (block 710), and stores such question(s) in the example mobile message prompt library 318 (block 712). While one or more respondent surveys could be conducted based on live transmission and reception between the mobile device 116 and the central diary manager 140, in the event that the mobile device 116 is out of wireless communication range, the mobile message prompt library 318 stores one or more respondent survey questions to be presented to the respondent at a later time (e.g., after a time-period of sixty minutes as determined by the mobile respondent timer 304).

The example mobile respondent timer 304 also monitors for a time-period expiration and/or a scheduled date/time (block 714). If the mobile respondent timer 304 does not meet a time-period threshold (e.g., once every sixty minutes) and/or a scheduled date/time (block 714), then the example mobile device interface 302 of the mobile device manager 124 determines whether the central diary manger 140 has initiated a request to conduct a respondent survey (block 716). If not, then the mobile device manager 124 waits for one or more signal(s) to initiate a respondent survey (block 714). On the other hand, if the mobile respondent timer 304 meets a time-period threshold (block 714) and/or if the central diary manager 140 initiates a request to conduct a respondent survey (block 716), then the example mobile triggered probe 306 retrieves a survey question (e.g., a first survey question set) from the mobile message prompt library 318 (block 718). Additionally or alternatively, one or more respondent survey question(s) may be transmitted by the central diary manager 140 and received wirelessly by the mobile diary manager 124 for immediate presentation to the respondent (block 718). In either case, respondent survey questions are presented to the respondent via the example user interface display 120. The example first survey question set may be based on respondent characteristics including, but not limited to, engagement with a particular product, a particular person, a situation, an activity, a number of computers owned by the respondent, a number of televisions owned by the respondent, a number of game consoles owned by the respondent, respondent leisure activity preferences, and/or expected mood based on a day of week, a time of day, and/or a season of year.

In the illustrated example program 700 of FIG. 7, responses to the survey questions are entered by the respondent on the mobile device 116, such as via the example user input 122 (block 720). Responses may be provided via SMS messages, e-mail, audio voice responses, video, blog updates, and/or any combination thereof. In the event that the survey question requires one or more follow-up questions (block 722) (e.g., a second survey question set based on a previously disclosed mood), such as the example follow-up question 206 described in connection with FIG. 2, the mobile diary manager 124 transmits the respondent answer (i.e., the response to the previous survey question) to the central diary manager 140 where it is determined whether external data is needed (block 724). For example, if the previous survey question asked the respondent what he/she was doing, and the answer was “shopping,” then the central diary manager 140 may invoke the external data manager 412 (block 726) to consult the Claritas® database services to determine which retail establishments are in closest proximity to the mobile device, as determined by the previously received GPS coordinates. Control returns to block 718 where additional survey questions are presented to the respondent. On the other hand, if external data is not needed (block 724) due to, for example, a lack of communicative activity with the central diary manager 140, then control returns to block 718 where additional survey questions are presented to the respondent based on one or more follow-up questions retrieved from the mobile message prompt library 318, which is local to the mobile device 116.

In the illustrated example program 700 of FIG. 7, responses entered on the mobile device 116 by the respondent are transmitted to the central diary manager (block 728) and the mobile device interface 302 determines whether transmission was successful (block 730). Upon confirmation of successful transmission (block 730), control returns to block 714 to initiate another respondent survey in response to a scheduled, manual, and/or time-period expiration. On the other hand, if transmission is not deemed successful (block 730) due to, for example, a lack of wireless communication, building interference, etc., then responses entered by the respondent from the survey are stored locally within the mobile device 116 (block 732). For example, survey responses may be stored in the example mobile survey response library 316 shown in FIG. 3.

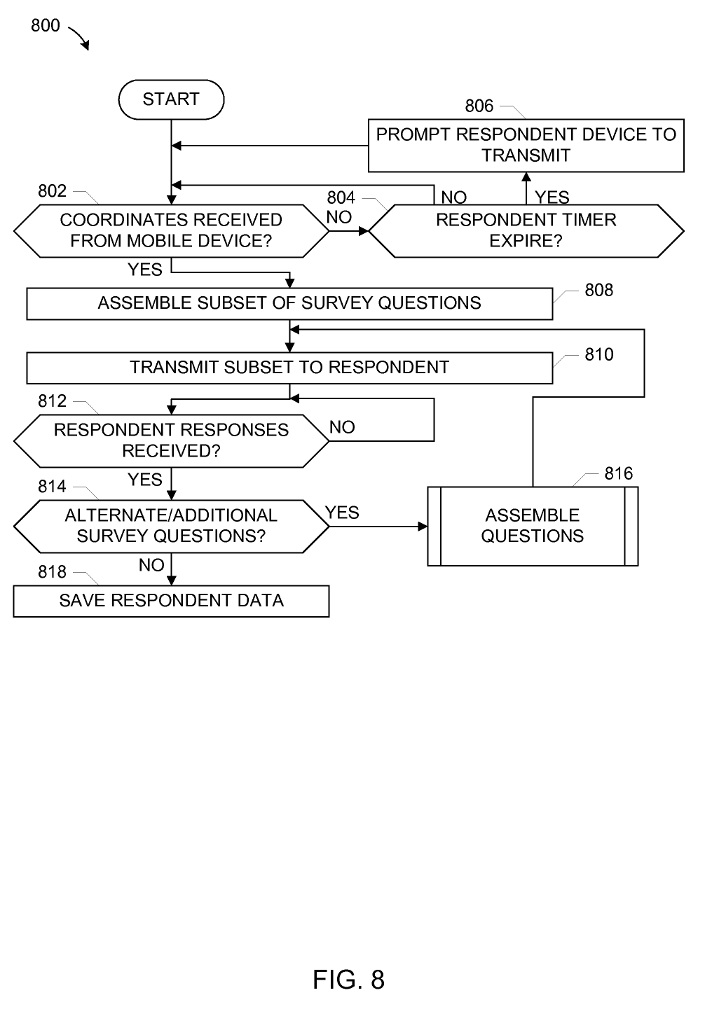

FIG. 8 is a flowchart representative of machine readable instructions 800 that may be executed to facilitate one or more features of the example central diary manager 140 of FIGS. 1 and 4. The program 800 of FIG. 8 begins at block 802 where the communication interface 402 of the central diary manager 140 determines whether location coordinates are available for a respondent. If not, the central diary manager 140 determines whether a time-period has elapsed to invoke the mobile device 116 for information and/or to initiate a respondent survey (block 804). If not, then the central diary manager 140 continues to wait for a signal from the example central respondent timer 404 to identify when information and/or initiation of a respondent survey should proceed. However, as described above, the example mobile diary manager 124 also includes a respondent timer (i.e., the mobile respondent timer 304) that, when activated due to the expiration of a time-period, causes the mobile diary manager 124 to communicate with the central diary manager 140.

In the event that the central respondent timer 404 reaches the time-period (e.g., a predetermined threshold time-period of sixty minutes), the example communication interface 402 of the central diary manager 140 transmits a communication request to the mobile diary manager 124 to send location coordinates of the mobile device 116 (block 806). The central diary manager 140 determines whether such location coordinates are received (block 802) and, if so, assembles a subset of survey questions based on any number of parameters (block 808). As described above, an initial set of survey questions may be based on, but not limited to, respondent characteristics, respondent preferences, respondent current mood, respondent expected mood, and/or temporal parameters (e.g., day of week, hour of day, season, etc.) For example, if location coordinates are not available (e.g., due to poor GPS coverage, a mobile device without GPS functionality, etc.), then the central message generator 406 generates one or more survey questions (e.g., a subset of survey questions, such as the questions described in connection with FIG. 2) based on the time of day, the day of the week, and/or seasonal information (block 808). On the other hand, if location coordinates are available, the external data manager 412 of the central diary manager 140 invokes one or more external data sources to learn more information about the environment associated with the received location coordinates. Such environmental information may be received from the Claritas® database and/or TDLinx® database to identify which retailers are near the mobile device 116. As a result, the example central message generator 406 assembles one or more candidate survey questions, such as questions stored in the central survey library 418, based on, for example, the particular stores, store types, known store promotions, etc, and transmits such subset of questions to the mobile diary manager 124 (block 810). In one example, if the external data manager 412 reveals, after one or more queries to external data sources, that the mobile device 116 is near a Starbucks® coffee store, one or more of the questions assembled by the central message generator 406 may ask whether the respondent has purchased coffee, whether the respondent is satisfied with their particular product choice (e.g., instances of buyer regret), and/or whether the respondent was aware of one or more additional options.

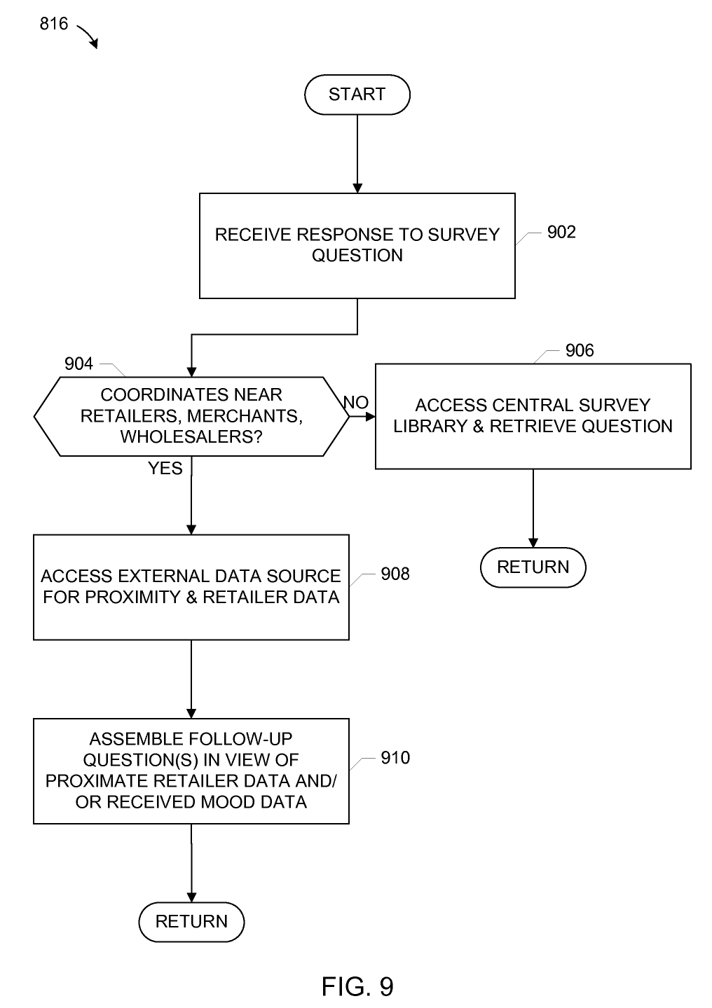

Upon receipt of survey question responses (block 812), the central message generator 406 determines whether alternate and/or additional survey questions should be transmitted back to the respondent (e.g., follow-up questions) (block 814). For example, in the event that the respondent did purchase coffee from Starbucks®, one or more branch questions may be transmitted to the respondent to determine whether non-coffee related products were also purchased at the store (e.g., coffee filters, a copy of a music CD playing in the store, coffee mug, etc.). In the illustrated example program 800 of FIG. 8, such additional and/or alternate survey questions are assembled based on one or more queries to external data source(s) (block 816), as described further below in connection with FIG. 9. However, when the survey is complete, responses to the respondent survey are saved to the database 138, such as the raw data memory 422 of the database 138, for later evaluation (block 818).

FIG. 9 is a flowchart representative of machine readable instructions 816 to assemble one or more alternate and/or additional survey questions for a respondent to answer during a survey. The program of FIG. 9 (816) begins at block 902 where the respondent response(s) are received by the central message generator 406. In the event that the received response(s) also include location coordinates, the central message generator 406 determines whether such location coordinates are also near known retailers and/or merchants (block 904). If not, then any follow-up questions to be transmitted back to the respondent may be obtained from the central survey library 418 (block 906) (e.g., pre-determined branch questions). However, if retailers and/or merchants are in proximity to the mobile device 116 carried by the respondent, the external data manager 412 of the central diary manager 140 is invoked to query external data sources for information related to such proximate stores (block 908). In view of additional details related to retailers and/or merchants, the example central message generator 406 assembles additional and/or alternate survey questions based on the received external data and/or mood data (block 910).

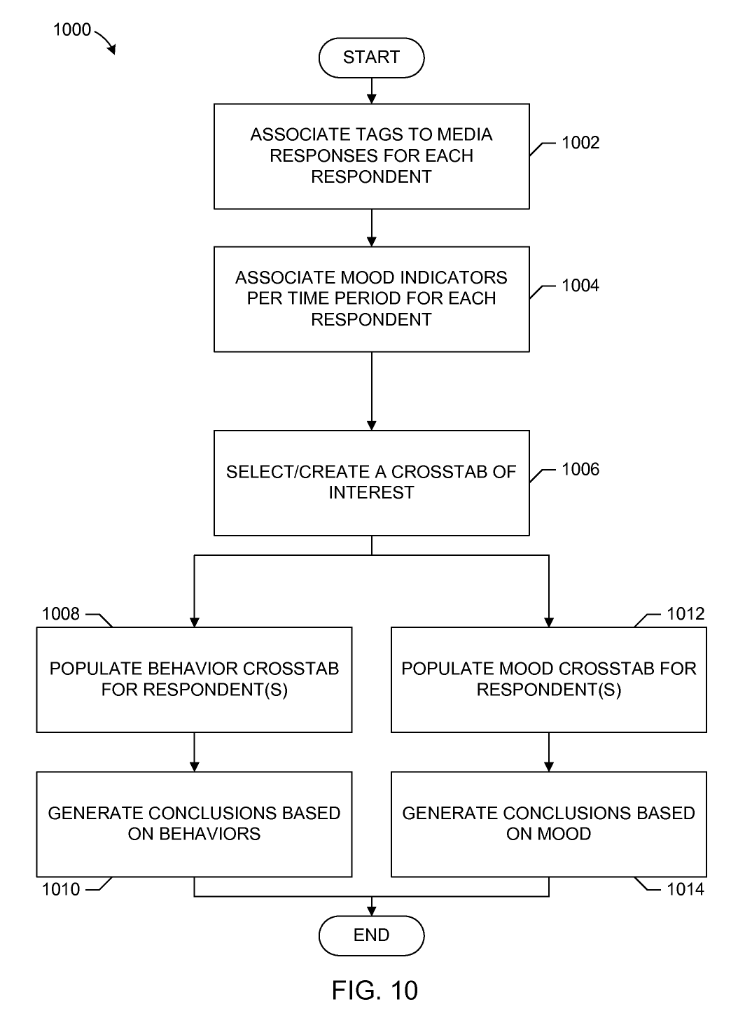

FIG. 10 is a flowchart representative of machine readable instructions 1000 that may be executed to generate one or more behavioral and/or perspective conclusions based on the received respondent survey data. The program of FIG. 10 (1000) begins at block 1002 where the example media tag manager 410 associates at least one tag to each of the responses received from the respondent(s). For example, during each survey the respondent is asked about their engagement in a particular activity and/or what his/her associated mood is (e.g., happy, sad, enthusiastic, etc.). Also during each survey, the respondent may provide answers to one or more questions and provide one or more other types of media (e.g., a picture, an audio sample). Each of the response questions and media is tagged by the example media tag manager 410 with the mood identified during that survey time (block 1002).

Additionally, the example perspectives manager 416 associates, on a respondent-by-respondent basis, a mood for each time of day (block 1004). For example, one respondent may perform six or more surveys per day in which each survey is associated with a mood tag (e.g., a numerical value of mood based on a number scale between 1 (depressed) and 10 (happy)). As such, the perspectives manager 416 associates the identified mood value with each discrete time of day to, in part, illustrate any mood trends of the respondent(s), as described in view of FIG. 6 above.

In the illustrated example program 1000 of FIG. 10, the behavior manager 414 selects a cross-tab of interest (block 1006), which may include any combination of respondent characteristics. Respondent characteristics may include, but are not limited to, the number of roommates, marital status, financial status, number of televisions, number of computers, and/or number of game consoles. Any combination of interest (crosstab) may be selected/created by the behavior manager 414 (block 1006), such as the example crosstab that includes individuals having three or more computers, three or more televisions, and three or more game consoles, described above in connection with FIGS. 5 and 6 (e.g., Fred, Janice, and Nick). The example behavior manager 414 further populates each respondent associated with the selected crosstab of interest with behavior data (block 1008) and employs the behavior algorithms library 424 to calculate and/or determine one or more conclusions associated with each respondent (block 1010).

Additionally, the example perspectives manager 416 also populates the crosstab of interest with mood data associated with each respondent of the crosstab (block 1012), as shown in FIG. 6. The behavior algorithms library 424 is invoked to reveal one or more conclusions and/or trends associated with the mood data for each respondent (block 1014).

Generally speaking, the methods and apparatus described herein employ quantitive inputs having one or more discrete units of measurement. For example, some of the information acquired from respondents directly relates to a measurable quantity, such as a quantity of goods purchased during a shopping trip, a quantity of friends present during one or more activities, and/or a discrete amount of time spent on one or more activities. On the other hand, the methods and apparatus described herein also employ qualitative inputs that may not include an associated discrete unit of measurement. For example, one or more photos captured by a respondent depicting a sunset scene, a skyscraper, and/or a relatively messy office desk do not have any associated discrete metric associated therewith. Similarly, one or more statements (e.g., “Oh my goodness, I can feed my family for a month because of the supermarket pasta sale!”), videos, and/or audio responses (e.g., “What an amazing cleaning product!”) by the respondent also lack a discrete unit of measurement.

In an effort to take advantage of consumer cues related to motivations and attitudes regarding actual purchase behavior at the moment such purchasing (and/or other behaviors) occurs, the methods and apparatus described herein employ one or more cues from both quantitative data and qualitative data. In some situations, consumers do not recall how they made a decision to purchase, not purchase, purchase a trial size, purchase a bonus size, etc. Further, some consumer choices are driven by unconscious motivations and, despite what a consumer may state as one or more reasons for behaving in a certain manner, what consumers claim as behavior may be different from their actual behavior. As such, collection and/or analysis of ethnographic characteristics of one or more consumers allows the market researcher to obtain cues, such as consumer mood, that affect consumer behavior when making purchasing decisions.

FIG. 11 is a flowchart representative of machine readable instructions 1100 that may be executed to utilize qualitative data, quantitative data, and empirical panelist data to verify context coding efforts of the qualitative data. The program of FIG. 11 (1100) begins at block 1102 where the example mobile diary manager 124 obtains quantitative consumer data related to the respondent carrying the example mobile device 116 of FIG. 1. As described above in view of example FIG. 7, the mobile diary manager 124 may operate on a periodic, aperiodic, scheduled and/or manual basis to transmit coordinate information, conduct consumer survey(s), store responses, produce dynamic survey follow-up questions and/or transmit responses to the example central diary manager 140.

Additionally, the example mobile diary manager 124 may be configured to obtain qualitative consumer data associated with the consumer associated with the example mobile device 116 (block 1104). As described above, the example mobile device 116 may include user input 122, a camera 127, and/or audio capture device(s) (e.g., one or more microphones typically installed in wireless telephony devices). While such user input, such as images, movies, audio samples, and/or consumer text quotes (e.g., SMS text messages, e-mail messages responsive to survey question(s), etc.) responsive to a mood during purchasing behavior do not include one or more discrete units of measurement, one or more product specialists, industry experts, field technicians, and/or other industry researchers perform context coding of the received qualitative consumer data (block 1106). Generally speaking, the context coding of qualitative consumer data transforms one or more qualitative events into a discrete value capable of numerical processing, such as one or more statistical operations and/or projections.

However, due to such context coding being originally derived from human interpretation based on the one or more product specialists, industry experts, field technicians, and/or other industry researchers, the example process 1100 performs a context coding verification with empirical panelist data (block 1108). The empirical panelist data may include, but is not limited to panelist purchase data, such as that developed by The Nielsen Company®. In the event that the context coded qualitative consumer data does not reflect real-world empirical indicators, such as the panelist purchase data (block 1110), then control returns to block 1104 to allow additional qualitative data to be obtained. Any number of iterations may be performed until such context coding verification reaches a threshold value of statistical significance and/or acceptance. Otherwise, such coded qualitative consumer data, quantitative data and panelist data may be used to project conclusions to a larger population (block 1112).

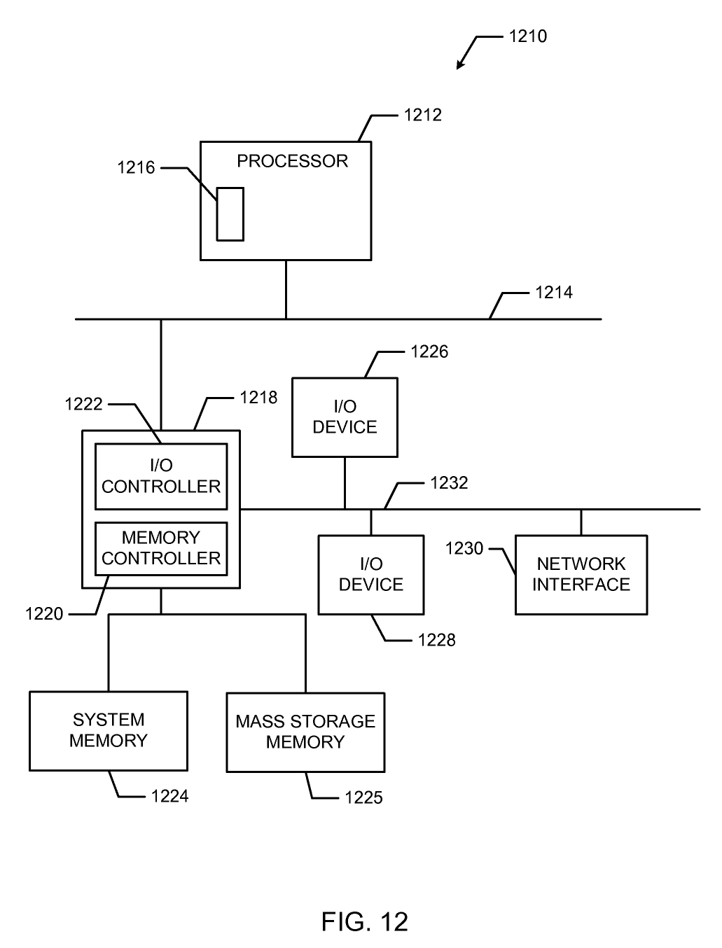

FIG. 12 is a block diagram of an example processor system that may be used to execute the example machine readable instructions of FIGS. 7-11 to implement the example systems and/or methods described herein. As shown in FIG. 12, the processor system 1210 includes a processor 1212 that is coupled to an interconnection bus 1214. The processor 1212 includes a register set or register space 1216, which is depicted in FIG. 12 as being entirely on-chip, but which could alternatively be located entirely or partially off-chip and directly coupled to the processor 1212 via dedicated electrical connections and/or via the interconnection bus 1214. The processor 1212 may be any suitable processor, processing unit or microprocessor. Although not shown in FIG. 12, the system 1210 may be a multi-processor system and, thus, may include one or more additional processors that are identical or similar to the processor 1212 and that are communicatively coupled to the interconnection bus 1214.

The processor 1212 of FIG. 12 is coupled to a chipset 1218, which includes a memory controller 1220 and an input/output (I/O) controller 1222. A chipset typically provides I/O and memory management functions as well as a plurality of general purpose and/or special purpose registers, timers, etc. that are accessible or used by one or more processors coupled to the chipset 1218. The memory controller 1220 performs functions that enable the processor 1212 (or processors if there are multiple processors) to access a system memory 1224 and a mass storage memory 1225.

The system memory 1224 may include any desired type of volatile and/or non-volatile memory such as, for example, static random access memory (SRAM), dynamic random access memory (DRAM), flash memory, read-only memory (ROM), etc. The mass storage memory 1225 may include any desired type of mass storage device including hard disk drives, optical drives, tape storage devices, etc.

The I/O controller 1222 performs functions that enable the processor 1212 to communicate with peripheral input/output (I/O) devices 1226 and 1228 and a network interface 1230 via an I/O bus 1232. The I/O devices 1226 and 1228 may be any desired type of I/O device such as, for example, a keyboard, a video display or monitor, a mouse, etc. The network interface 1230 may be, for example, an Ethernet device, an asynchronous transfer mode (ATM) device, an 802.11 device, a digital subscriber line (DSL) modem, a cable modem, a cellular modem, etc. that enables the processor system 1210 to communicate with another processor system.

While the memory controller 1220 and the I/O controller 1222 are depicted in FIG. 12 as separate functional blocks within the chipset 1218, the functions performed by these blocks may be integrated within a single semiconductor circuit or may be implemented using two or more separate integrated circuits.

Although certain methods, apparatus, systems, and articles of manufacture have been described herein, the scope of coverage of this patent is not limited thereto. To the contrary, this patent covers all methods, apparatus, systems, and articles of manufacture fairly falling within the scope of the appended claims either literally or under the doctrine of equivalents.

1. A computer implemented method to survey respondents, comprising:
transmitting a first survey question set to a wireless device associated with a respondent;
receiving a response from the wireless device, the response indicative of a mood of the respondent; and
transmitting a second survey question set to the respondent, the second survey question set based on the respondent mood.

2. A method as defined in claim 1, further comprising building the first survey question set for the respondent based on a current parameter of the respondent.

3. A method as defined in claim 2, wherein the current parameter comprises a current location of the respondent.

4-7. (canceled)

8. A method as defined in claim 1, wherein the respondent mood comprises at least one of happy, sad, angry, frustrated, confused, content, or pensive.

9-12. (canceled)

13. A method as defined in claim 1, further comprising building the first survey question set based on an expected mood associated with the respondent.

14. A method as defined in claim 13, wherein the expected mood of the respondent is based on previously measured mood data associated with the respondent.

15. A method as defined in claim 14, wherein the previously measured mood data is associated with at least one of a day of week, an hour of day, or a season of year.

16. A method as defined in claim 14, wherein the previously measured mood data comprises an average respondent mood for at least one of a day, an hour, or a season of year.

17-19. (canceled)

20. A method as defined in claim 1, further comprising receiving the response indicative of an activity of the respondent.

21. A method as defined in claim 20, further comprising transmitting the second survey question based on the respondent activity.

22. (canceled)

23. (canceled)

24. A method as defined in claim 1, wherein receiving the response from the wireless device further comprises receiving quantitative data associated with the respondent.

25. (canceled)

26. A method as defined in claim 24, further comprising context coding the response indicative of the respondent mood.

27. A method as defined in claim 26, further comprising verifying the context coded responses with an empirical indicator.

28. A method as defined in claim 27, wherein the empirical indicator comprises panelist data.

29. A method as defined in claim 26, further comprising projecting respondent behaviors based on the context coded responses indicative of mood.

30. A computer implemented method to survey respondents, comprising:
transmitting a first survey question set for a respondent on a wireless device associated with the respondent;
receiving a respondent response to the first survey question set via the wireless device, the respondent response to the first survey question set indicative of a current mood of the respondent;
receiving a second survey question set for the respondent based on the respondent response indicative of the current mood of the respondent; and
transmitting a respondent response to the second survey question set.

31. A method as defined in claim 30, wherein the second survey question set is tailored based on the current mood and an expected mood of the respondent.

32. A method as defined in claim 30, wherein the second survey question set is tailored based on the current mood and a profile of the respondent.

33. (canceled)

34. (canceled)

35. An apparatus to survey respondents, comprising:
a central diary manager communicatively connected to a wireless device associated with a respondent;
a central survey library to store a plurality of candidate survey questions for the respondent;
a respondent library to store respondent characteristics;
a communication interface to transmit a first survey question to the wireless device associated with the respondent, and to receive a first response based on the first survey question, the first response indicative of a mood of the respondent; and
a central message generator to generate a second survey question from the plurality of candidate survey questions based on the mood of the respondent.

36. An apparatus as defined in claim 35, further comprising an external data manager to identify a plurality of environmental conditions associated with the respondent.

37. (canceled)

38. (canceled)

39. An apparatus as defined in claim 36, wherein the message generator tailors at least one of the first or the second survey question based on the mood of the respondent and the plurality of environmental conditions associated with the respondent.

40-47. (canceled)
